(19) United States
(12) Patent Application Publication
(10) Pub. No.: US 2026/0055730 A1
(43) Pub. Date: Feb. 26, 2026

(54) EXHAUST SYSTEM FOR A TURBINE ENGINE, COMPRISING A HEAT EXCHANGER

(71) Applicant: SAFRAN NACELLES, Gonfreville-L'Orcher (FR)

(72) Inventors: Pierre Charles Caruel, Moissy-Cramayel (FR); Jean-Charles Michel Pierre Di Giovanni, Moissy-Cramayel (FR); Philippe Bienvenu, Moissy-Cramayel (FR); Pierre-François Behaghel, Moissy-Cramayel (FR); Michel Rognant, Moissy-Cramayel (FR)

(73) Assignee: SAFRAN NACELLES, Gonfreville-L'Orcher (FR)

(21) Appl. No.: 19/099,468

(22) PCT Filed: Jul. 28, 2023
(86) PCT No.: PCT/FR2023/051203

§ 371 Date: Jan. 28, 2025

(30) Foreign Application Priority Data
Aug. 2, 2022 (FR) FR2208020

(51) Int. Cl. F02C 7/10; F02C 7/224

(52) U.S. Cl. CPC F02C 7/10; F02C 7/224; F05D 2220/323; F05D 2260/205; F05D 2260/213

(57) ABSTRACT

This exhaust system for a turbine engine comprising a nozzle at least partly delimiting a gas exhaust path, comprises a heat exchanger comprising at least one distributor, at least one manifold and ducts configured for the flow of a heat-transfer fluid in said ducts between the distributor and the manifold, the heat exchanger being configured to carry out heat exchanges between the gas exhaust path and the ducts, and the heat exchanger being positioned on the nozzle, the ducts being partially formed from a surface of the nozzle.

### TECHNICAL FIELD

The present invention relates to heat recovery at the exhaust of a turbine engine.

In particular, the present invention relates to heat recovery for the purpose of heating fuel and/or air intended to enter a combustion chamber of said turbine engine.

In general, the invention applies to any type of exhaust system.

### PRIOR ART

FIG. 1 schematically shows a turbine engine 2 of an aircraft according to the prior art. The turbine engine 2 comprises a fan 4 making it possible to recover air coming from the atmosphere outside of the turbine engine 2, a compressor 6, a combustion chamber 8, a turbine 10, and an exhaust system 12. With a view to improving the performance of turbine engines, it is possible to heat the air leaving the compressor 6 and/or the fuel and/or entering the combustion chamber 8 with the air.

A heat source located nearby is preferred so as to increase the thermal efficiency of the turbine engine 2. A heat source is constituted, for example, by the gases leaving through the exhaust system 12, downstream of the turbine 10. However, the positioning of a heat exchanger in the primary exhaust flow 14, for example in the form of fins positioned in the flow, induces pressure drops of the turbine engine 2, which negatively impacts the thrust of the aircraft. The positioning of a heat exchanger in the turbine engine 2 also adversely affects the compactness of said turbine engine 2.

### DISCLOSURE OF THE INVENTION

The aim of the present invention is therefore to overcome the above-mentioned drawbacks and to provide an exhaust system making it possible to efficiently recover heat at the exhaust of a turbine engine. To this end, the invention is the result of technological research aiming to very significantly improve aircraft performance and, in this sense, contributes to reducing the environmental impact of aircraft.

The object of the present invention is an exhaust system for a turbine engine comprising a nozzle at least partly delimiting a gas exhaust path, the exhaust system further comprising a heat exchanger comprising at least one distributor, at least one manifold and ducts configured for the flow of a heat-transfer fluid in said ducts between the distributor and the manifold, the heat exchanger being configured to carry out heat exchanges between the gas exhaust path and the ducts, and the heat exchanger being positioned on the nozzle, the ducts being partially formed from a surface of the nozzle.

Thus, the exhaust system according to the invention makes it possible to recover heat at the exhaust of a turbine engine at the periphery of the exhaust path without inducing significant pressure drops for the turbine engine, the heat exchanger being particularly compact and non-invasive.

Preferably, the nozzle comprises an annular outer part and a central body, the heat exchanger being positioned on the outer part and/or on the central body.

Advantageously, the outer part of the nozzle comprises one or more annular sectors.

In various embodiments, the ducts are positioned outside or inside the gas exhaust path.

In one embodiment, the ducts have a cross-section of semicircular, or rectangular, or bell-shaped, or semi-elliptical, or triangular shape.

Advantageously, the ducts extend longitudinally parallel to a longitudinal axis of the exhaust system, or transversely to the longitudinal axis.

In one embodiment, the exhaust system is made of a material comprising a titanium alloy and/or a nickel alloy.

Advantageously, the heat exchanger is configured to carry out heat exchanges between exhaust gases leaving through the gas exhaust path and a heat-transfer fluid flowing in the ducts, said heat-transfer fluid comprising air and/or water vapour and/or water and/or fuel and/or oil and/or supercritical CO2 and/or liquid or gaseous hydrogen.

Another object of the present invention is a turbine engine comprising a compressor, a combustion chamber and an exhaust system as defined above, the heat exchanger being configured to heat fuel at the inlet of the combustion chamber and/or air at the outlet of the compressor before it enters the combustion chamber.

Another object of the present invention is an aircraft comprising a turbine engine as defined above and/or an exhaust system as defined above.

The present invention further relates to the use of the exhaust system as defined above in a thermal management system for heating air or fuel in a turbine engine.

### BRIEF DESCRIPTION OF THE DRAWINGS

Other aims, features and advantages of the invention will become apparent upon reading the following description, given merely as a non-limiting example, and made with reference to the appended drawings, wherein:

FIG. 1 is a longitudinal and schematic sectional view of a turbine engine of an aircraft according to the prior art;

FIG. 2 is a longitudinal and schematic sectional view of a turbine engine of an aircraft according to the invention;

FIG. 3 is a schematic view of a first embodiment of an exhaust system for a turbine engine according to the invention;

FIG. 4 is a schematic view of a first variant of the first embodiment of an exhaust system for a turbine engine illustrated in FIG. 3;

FIG. 5 is a schematic view of a second variant of the first embodiment of an exhaust system for a turbine engine illustrated in FIG. 3;

FIG. 6 is a schematic view of a third variant of the first embodiment of an exhaust system for a turbine engine illustrated in FIG. 3;

FIG. 7 is a schematic view of a second embodiment of an exhaust system for a turbine engine according to the invention;

FIG. 8 is a schematic view of the first embodiment of an exhaust system of FIG. 3 comprising an outer skin;

FIG. 9 is a schematic sectional view of ducts the cross section of which is semicircular; and

FIG. 10 is a schematic sectional view of ducts the cross-section of which is triangular.

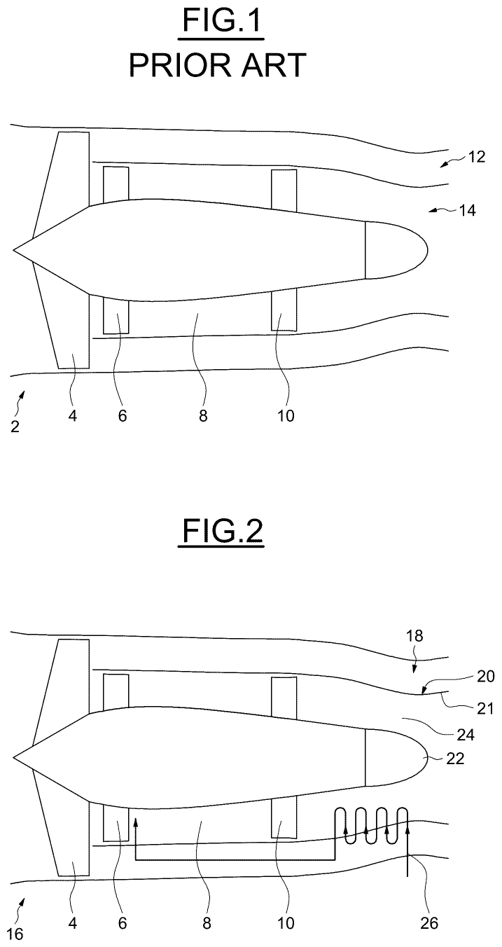

### DETAILED DISCLOSURE OF AT LEAST ONE EMBODIMENT

FIG. 2 schematically shows a turbine engine 16 of an aircraft according to the invention. The turbine engine 16 comprises a fan 4 making it possible to recover air coming from the atmosphere outside of the turbine engine 16, a compressor 6, a combustion chamber 8, a turbine 10, and an exhaust system 18.

In particular, the exhaust system 12 comprises a nozzle 20 preferably comprising an annular outer part 21 and a central body 22 forming a gas exhaust path 24 of annular section. The exhaust system 18 also comprises a heat exchanger 26 configured to heat fuel at the inlet of the combustion chamber 8 and/or air at the outlet of the compressor 6 and before it enters the combustion chamber 8.

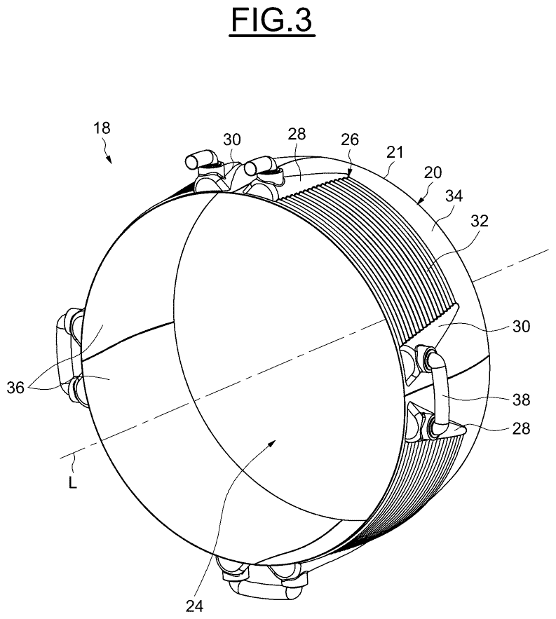

FIG. 3 schematically shows a first embodiment of an exhaust system 18 wherein the heat exchanger 26 is positioned on the outer part 21 of the nozzle 20, the central body 22 not being shown in FIG. 3 as well as in the following figures. As a variant, by analogy, the heat exchanger 26 can be positioned on the central body 22 of the exhaust system 18.

The heat exchanger 26 comprises at least one distributor 28, at least one manifold 30 and ducts 32.

The distributor 28 is configured to inject a heat-transfer fluid into the ducts 32 themselves configured for the flow of said heat-transfer fluid in said ducts 32 up to a manifold 30 configured to recover the heated heat-transfer fluid.

The heat-transfer fluid comprises, for example, air, and/or water vapour, and/or water, and/or fuel, and/or oil, and/or supercritical CO2 and/or liquid hydrogen, and/or fuel for supplying the turbine engine 16. Liquid hydrogen can, for example, be used as a fuel and is advantageously used as a heat-transfer fluid since it is a cold fuel, the boiling temperature thereof being about 20 Kelvin.

The ducts 32 are partially formed from a surface 34 of the outer part 21 of the nozzle 20 or from a surface of the central body, if applicable. The surface is a surface of the wall of the nozzle, also known as the primary exhaust wall, on contact with which exhaust gases are expelled.

The ducts 32, as well as the distributors 28 and manifolds 30 are preferentially positioned on the outer surface 34 of the wall of the outer part 21 of the nozzle 20, in other words outside the exhaust path 24 so as not to disturb the exhaust flow. As a variant, the ducts 32 can nevertheless be positioned on the inner surface of the wall of the nozzle 20, in other words inside the exhaust path 24. Advantageously, the ducts 32 are distributed over the entire periphery of the exhaust path 24.

Thus, the heat exchanger 26 is configured to carry out heat exchanges between the gas exhaust path 24 and the ducts 32 via the wall(s) of the nozzle 20.

The exhaust system 18 as shown in FIG. 3 comprises four annular sectors 36 of substantially the same dimensions, at least one manifold 30, at least one distributor 28 and ducts 32 being positioned on each sector 36, the manifold 30 and distributor 28 adjoining two different sectors 36 being connected by a tube 38. In a variant, the exhaust system 18 comprises a single annular sector or a plurality of annular sectors.

In the embodiment illustrated in FIG. 3, the ducts 32 extend along the periphery of the outer part 21 of the nozzle 20, transversely to the longitudinal axis L of the exhaust system 18.

In addition, the heat exchanger 26 comprises non-bent ducts 32, the only curvature of which is the curvature of the outer part 21 of the nozzle 20.

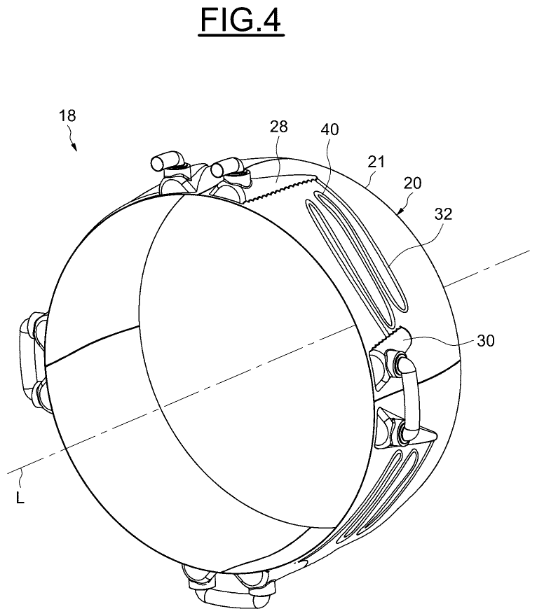

FIG. 4 schematically shows a first variant of the first embodiment.

In this first variant, the ducts 32 extend along the periphery of the outer part 21 of the nozzle 20 while meandering. In particular, the ducts 32 have elbows 40 with an angle substantially equal to 180° so that each manifold 30 and distributor 28 comprises few inlets and outlets to ducts 32, so as to minimise the flow of fluid passing through the exchanger.

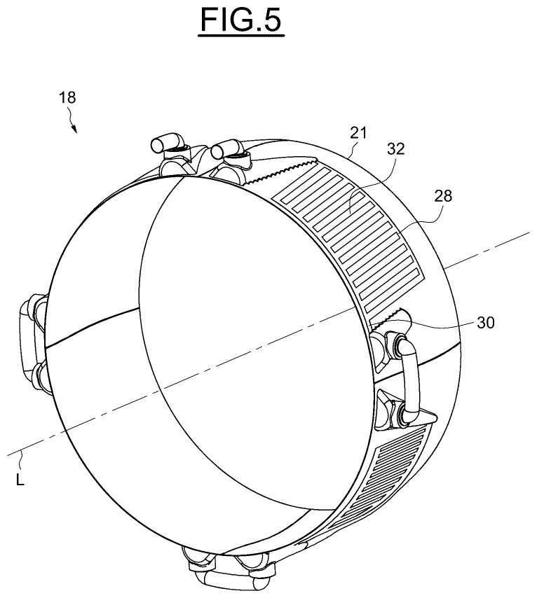

FIG. 5 schematically shows a second variant of the first embodiment. This variant is identical to the embodiment of FIG. 3, except that the ducts 32 extend longitudinally and substantially parallel to the longitudinal axis L of the exhaust system 18.

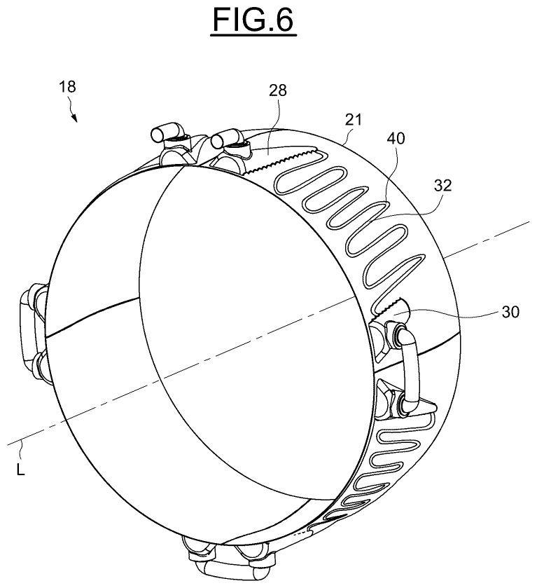

FIG. 6 schematically shows a third variant of the first embodiment. This variant is identical to the embodiment of FIG. 4, except that the ducts 32 extend longitudinally and substantially parallel to the longitudinal axis L of the exhaust system 18. The ducts 32 also have elbows 40 with an angle substantially equal to 180°.

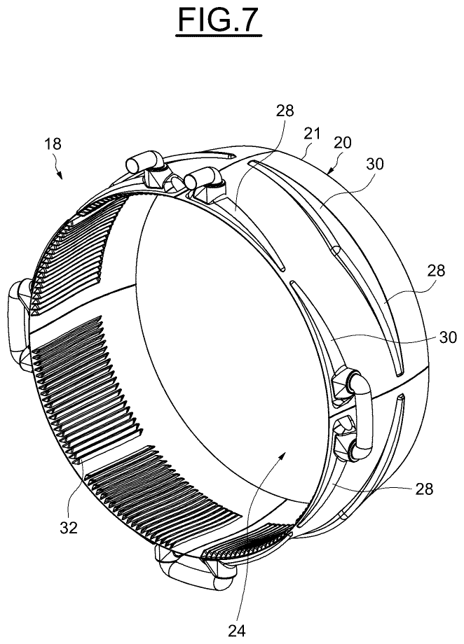

FIG. 7 schematically shows a second embodiment of an exhaust system 18 wherein the heat exchanger 26 is positioned on the outer part 21 of the nozzle 20.

In this embodiment, the ducts 32 are positioned inside the exhaust path 24 while the distributors 28 and manifolds 30 are positioned outside the exhaust path 24. The ducts 32 extend substantially parallel to the longitudinal axis L of the exhaust system 18.

This embodiment makes it possible to increase the heat exchange surface, to the detriment of a slight pressure drop in the primary flow of the turbine engine.

In each embodiment, the exhaust system 18 is made of a thermally resistant material, for example a material comprising a titanium alloy and/or a nickel alloy.

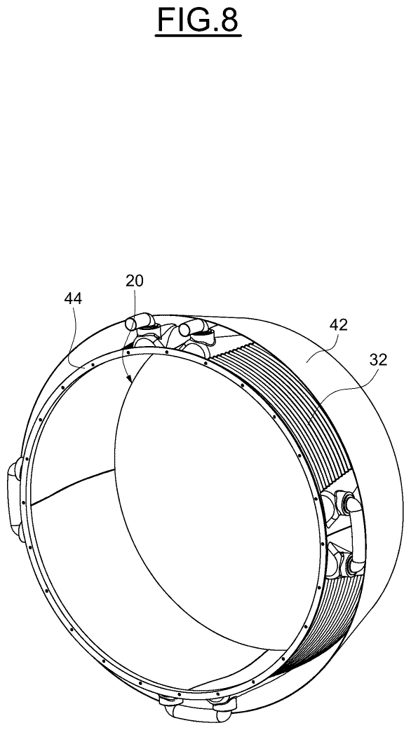

In each embodiment, the exhaust system 18 may optionally comprise an outer skin 42, as illustrated in FIG. 8, disposed annularly around the heat exchanger 18 and serving as an aerodynamic fairing of the flow of the secondary path or of any other flow coming from the turbine engine. The exhaust system may also comprise a flange 44 at the longitudinal end of the nozzle 20 so as to attach said nozzle 20 to the turbine engine 2.

In various embodiments, the ducts 32 have, for example, a cross-section of semicircular, or rectangular, or bell-shaped, or semi-elliptical, or also triangular shape. The shape of the section of the ducts 32 further makes it possible for the ducts to be easily removed from the mould during the manufacture thereof.

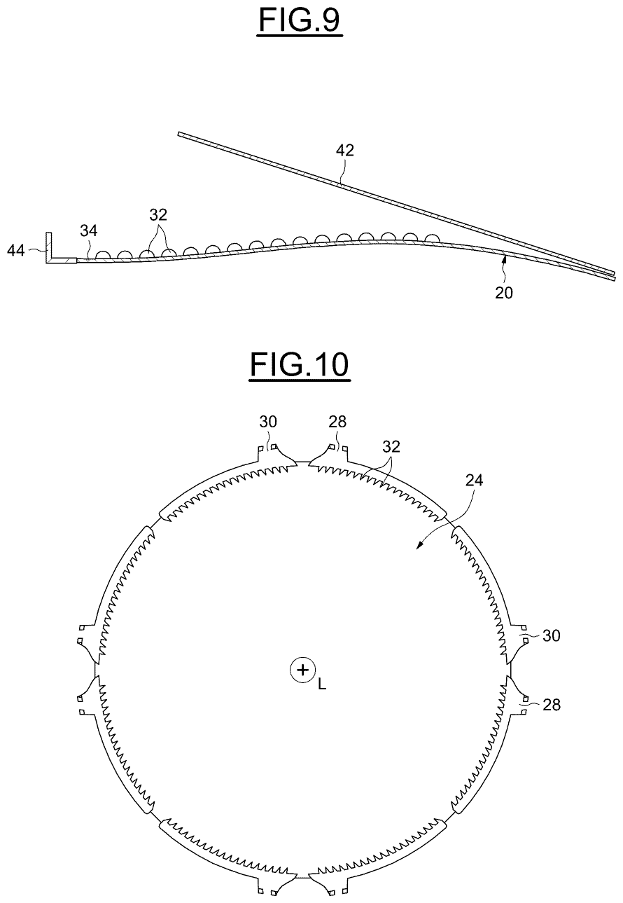

FIG. 9 schematically shows a sectional view of ducts 32 the cross-section of which is semicircular. The sectional view here is taken along the longitudinal axis of the exhaust system 18. The ducts 32 shown are, for example, the ducts 32 shown in the embodiment of FIG. 3. They are protected by the outer skin 42.

FIG. 10 shows a sectional view of ducts 32 the cross-section of which is triangular. The sectional view is taken transversely to the longitudinal axis L of the exhaust system 18. The ducts 32 shown are, for example, the ducts 32 shown in the embodiment of FIG. 7, wherein the ducts 32 are positioned in the exhaust path 24 and extend parallel to the longitudinal axis L of the exhaust system. The triangular section of the ducts 32 makes a large heat exchange surface and a low pressure drop possible. In addition, one of the sides of each duct 32 is advantageously oriented radially in the direction of the longitudinal axis L, thus making it possible to be easily removed from the mould during the manufacture of the exhaust system 18.

In addition, for each embodiment, manufacturing is preferably carried out by diffusion welding a stack of a plurality of sheets, an inert gas being injected at the desired location of the ducts 32. Diffusion welding makes it possible to avoid a reduction in the welds, and thus makes it possible to produce an exhaust system 18 having substantially the same properties as if the latter were produced in one piece.

1. Exhaust system for a turbine engine comprising a nozzle at least partly delimiting a gas exhaust path, a heat exchanger comprising at least one distributor, at least one manifold and ducts configured for the flow of a heat-transfer fluid in said ducts between the distributor and the manifold, the heat exchanger being configured to carry out heat exchanges between the gas exhaust path and the ducts, and the heat exchanger being positioned on the nozzle, the ducts being partially formed from a surface of the nozzle.

2. Exhaust system according to claim 1, wherein the nozzle comprises an annular outer part and a central body, the heat exchanger being positioned on the outer part and/or on the central body.

3. Exhaust system according to claim 2, wherein the outer part of the nozzle comprises one or more annular sectors.

4. Exhaust system according to claim 1, wherein the ducts are positioned outside or inside the gas exhaust path.

5. Exhaust system according to claim 1, wherein the ducts extend longitudinally parallel to a longitudinal axis of the exhaust system, or transversely to the longitudinal axis.

6. Exhaust system according to claim 1, made of a material comprising a titanium alloy and/or a nickel alloy.

7. Exhaust system according to claim 1, wherein the heat exchanger is configured to carry out heat exchanges between exhaust gases leaving through the gas exhaust path and a heat-transfer fluid flowing in the ducts, said heat-transfer fluid comprising air and/or water vapour and/or water and/or fuel and/or oil and/or supercritical CO2 and/or liquid or gaseous hydrogen.

8. Turbine engine comprising a compressor and a combustion chamber, an exhaust system according to claim 1, the heat exchanger being configured to heat fuel at the inlet of the combustion chamber and/or air at the outlet of the compressor before it enters into the combustion chamber.

9. Aircraft comprising a turbine engine according to claim 8.

10. Use of the exhaust system according to claim 1 in a thermal management system for heating air or fuel in a turbine engine.

11. Aircraft comprising an exhaust system according to claim 1.
